(19) United States
(12) Patent Application Publication
(10) Pub. No.: US 2008/0040700 A1
(43) Pub. Date: Feb. 14, 2008

(54) Behavioral synthesizer, debugger, writing device and computer aided design system and method

(75) Inventors: Yoshinosuke Katoh, Tokyo (JP); Toru Awashima, Tokyo (JP); Noritsugu Nakamura, Tokyo (JP); Hirokazu Kami, Tokyo (JP); Takao Toi, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/727,948

(22) Filed: Mar. 29, 2007

(30) Foreign Application Priority Data
Mar. 31, 2006 (JP) 2006-099071

(51) Int. Cl. G06F 17/50

(52) U.S. Cl. 716/18

(57) ABSTRACT

The liveness information that is obtained from behavioral synthesis and that shows the periods during which variables described in a behavioral level description have valid values is used for processing at a logic synthesizing stage, placement and routing stage, debugging stage, writing stage of circuit information to a reconfigurable device, or the like, so as to use storage elements that are to be allocated to the variables described in the behavioral level description in common and to achieve optimization such as minimizing data paths and the like. Also in a debugger and in a writing device for writing circuit information, the aforementioned liveness information is used to execute a task of not displaying invalid variables, a task of reducing the amount of information to be saved to an external memory, etc.

### BACKGROUND OF THE INVENTION

This application is based upon and claims the benefit of priority from Japanese Patent Application No. 2006-099071 filed on Mar. 31, 2006, the content of which is incorporated by reference.

1. Field of the Invention

The present invention relates to a behavioral synthesizer and debugger for supporting circuit design for generating information showing the configuration, placement and routing of a specific circuit based on a behavioral level description that describes the operation of a semiconductor integrated circuit and a writing device for the information as well as to a computer aided design system and method.

2. Description of the Related Art

Information processing devices, as their usage range becomes wide, are required to have capabilities for handling higher operation processes and for processing a large amount of data such as images and motion pictures at high speeds. As a technique for meeting such demands, a conventional information processing device adopts a configuration in which, in addition to a CPU, a DSP (digital signal processor), ASIC (application specific integrated circuit) or the like for execution of specific operations and jobs is provided so as to improve its processing capability by reducing the processing load on the CPU.

Recent information processing devices, however, need to implement compression/expansion processes of various specifications and operation processes to deal with multi media such as images, motion pictures, voice sound and music etc. Further, a variety of protocols have come to be used for the communication process of transmitting and receiving various types of data via the internet and other networks. Moreover, since there is a safety issue regarding information being exchanged on networks, information processing devices are also required to carry out an encrypting process for information security and for the decrypting process. However, if as many DSPs, ASICs and the like as these various processes are provided, the circuit scale of such an information processing device and its cost will increase too much.

To deal with this, there is a known technique which improves the throughput of an information processing device and enables handling of various processing requests while reducing its cost by using an information processing device provided with a reconfigurable device such as an FPGA (field programmable gate array), DRP (dynamically reconfigurable processor) or the like and by implementing a rewriting process of the program in the reconfigurable device as required.

A reconfigurable device includes an internal memory for storing programs (configuration codes) therein. The reconfigurable device loads a configuration code stored in an external memory into the internal memory under the control of a CPU or the like, configures a circuit therein in accordance with the loaded configuration code and executes a task to input data with this circuit. The reconfigurable device also has registers for temporarily holding the data necessary for processing and the result of processing. This internal memory not only stores the configuration code but may also temporarily store tables and data which are referred to during the execution of a task. Hereinbelow, a register provided for a reconfigurable device and the internal memory for holding the information required for a task will be generally referred to as a storage element.

In general, in designing a semiconductor integrated circuit device such as LSI, VLSI or the like, an LSI design automation and supporting tool for supporting design and automating part of designing operation is used. As a typical scheme of VLSI design utilizing this LSI design automation and supporting tool, there is a top-down design method that uses various EDA (electronic design automation) tools. The top-down design method can be roughly divided into a behavioral level design phase, a function design phase, a logic design phase and a layout design phase.

In the top-down design method, first an LSI, the target to be designed is regarded as a system, and its operation is described as a preparation step of the system specification. This step is called the behavioral level design phase. The circuit description prepared in the behavioral level design phase is called a behavioral level description. This behavioral level description is prepared in C language, C++ language, Java language or the like.

In the function design phase, the behavioral level circuit description prepared in the behavioral level design phase is converted into a RTL (register transfer level) circuit description by a behavioral synthesizer. The RTL circuit description is a description that embodies the circuit that is to be designed with operations on every clock cycle.

In the logic design phase, the RTL circuit description prepared in the function design phase is converted into a logic level circuit description (a description with logic gate circuitry or a net list). The net list generated by logic synthesis is used for layout design at the layout design phase, and chip design is done based on the circuit pattern prepared by the layout design.

Also for the aforementioned reconfigurable device, similarly to the aforementioned design of an LSI, VLSI or the like, a design automation and supporting tool (computer aided design system) for supporting design and supporting debugging operation is used in order to generate a configuration code or a net list. In the computer aided design system for reconfigurable devices, a behavioral synthesizer allocates storage elements to individual variables by performing behavioral synthesis of an input behavioral level description, for example. Also, a net list of the circuit is generated by performing logic synthesis of the output after behavioral synthesis, so that a placement and routing (layout) process is carried out based on the net list so as to generate a configuration code. The thus generated configuration code is loaded by using a configuration loader (writing device) including a CPU and the like or by directly loading the code into the reconfigurable device and is executed. Also, the generated configuration code is verified by observing the contents of the storage elements during execution of the task in the reconfigurable device, by using a debugging device.

Related to the above, as an LSI design automation and supporting tool, there is a computer aided design system described in patent document 1 (Japanese Patent Application Laid-open No. 2005-242812). As a tool for supporting program debugging, there is a debug supporting device described in patent document 2 (Japanese Patent Application Laid-open No. H11-194957).

As to the aforementioned DRP, detailed description is given in, for example, patent document 3 (Japanese Patent Application Laid-open No. 2001-312481), patent document 4 (Japanese Patent Application Laid-open No. 2003-196246) and non-patent document 1 (Hideharu Amano, Akiya Jouraku, Kenichiro Anjo, “A dynamically adaptive switch fabric on a multicontext reconfigurable device”, Proceeding of International Field Programmable Logic and Application Conference, September 2003, p 161-170.) and the like.

In the circuit design using the aforementioned design automation and supporting tools, in general a circuit is designed on the assumption that the information held in the storage elements is always valid.

However, in an actual circuit operation, there is a period during which the information held in a storage element is invalid depending on the task being executed. Since the conventional behavioral synthesizer does not recognize the periods during which information held in storage elements are invalid, it was impossible to realize optimized design such as, for example, sharing one register with multiple variables and other ways. Also, since the conventional debugger does not recognize the periods during which information held in storage elements are invalid, there occur cases where the content of a storage element that holds information having no relation to the task in progress may be displayed, which leads to waste in the operation.

### SUMMARY OF THE INVENTION

It is therefore an object of the present invention to provide a behavioral synthesizer, debugger, writing device and computer aided design system and method, which can eliminate wasted operation and realize circuit design optimization.

In the present invention, in order to achieve the above object, the liveness information that is obtained from behavioral synthesis and shows the periods during which variables described in a behavioral level description have valid values is used for processing at a logic synthesizing stage, placement and routing stage, debugging stage, writing stage of circuit information to a reconfigurable device, or the like, so as to use storage elements to be allocated to the variables described in the behavioral level description in common and achieve optimization such as minimizing data paths and the like. Also in a debugger and in a writing device for writing circuit information, the aforementioned liveness information is used to execute a task of not displaying invalid variables, a task of reducing the amount of information to be saved to an external memory, etc.

When the liveness information thus obtained by behavioral synthesis is used for processing at the logic synthesizing stage and at the placement and routing stage, design flexibility at the logic synthesizing stage and at the placement and routing stage is improved. When the liveness information is used for processing at the debugging stage, it is possible to eliminate the display of unnecessary information and to eliminate unnecessary operation. Further, when the liveness information is used at the time of switching circuits in a reconfigurable device (for the process at the stage of writing to a reconfigurable device), it is possible to reduce the amount of data to be saved from the reconfigurable device to an external memory. Accordingly, it is possible to eliminate wasted operation and to optimize circuit design.

The above and other objects, features, and advantages of the present invention will become apparent from the following description with reference to the accompanying drawing which illustrate an example of the present invention.

### BRIEF DESCRIPTION OF THE DRAWINGS

FIG. 1 is a block diagram showing a configuration of a computer aided design system of the present invention;

FIG. 2 is a block diagram showing a configuration of a behavioral synthesizer shown in FIG. 1;

FIG. 3 is a schematic diagram for illustrating liveness information used in a computer aided design system of the present invention;

FIG. 4 is a diagram showing a behavioral level description used in the first embodiment of a computer aided design system of the present invention and its behavioral synthesis result;

FIG. 5 is a diagram showing the result of processing of a computer aided design system in the first embodiment of the present invention;

FIG. 6 is a block diagram showing a configuration of a preferred computer aided design system to which the first embodiment is applied;

FIG. 7 is a diagram showing the result of processing of a computer aided design system in the second embodiment of the present invention;

FIG. 8 is a block diagram showing a configuration of a preferred computer aided design system to which the second embodiment is applied;

FIG. 9 is a diagram showing the result of processing of a computer aided design system in the third embodiment of the present invention;

FIG. 10 is a block diagram showing a configuration of a preferred computer aided design system to which the third and fourth embodiments are applied;

FIG. 11 is a diagram showing the result of processing of a computer aided design system in the fourth embodiment of the present invention;

FIG. 12 is a diagram showing the result of processing of a computer aided design system in the fifth embodiment of the present invention;

FIG. 13 is a block diagram showing a configuration of a preferred computer aided design system to which the fifth embodiment is applied; and

FIG. 14 is a diagram showing the result of processing of a computer aided design system in the sixth embodiment of the present invention.

### DESCRIPTION OF THE PREFERRED EMBODIMENT

Now, the present invention will be described taking an example of a system for generating configuration codes as programs for executing tasks in a reconfigurable device, but the present invention can also be applied to a computer aided design system for assisting the design of a semiconductor integrated circuit device such as an LSI, VLSI or the like. Here in this description, the registers provided for a reconfigurable device and the internal memory for holding information necessary for processing will be generally referred to as storage elements.

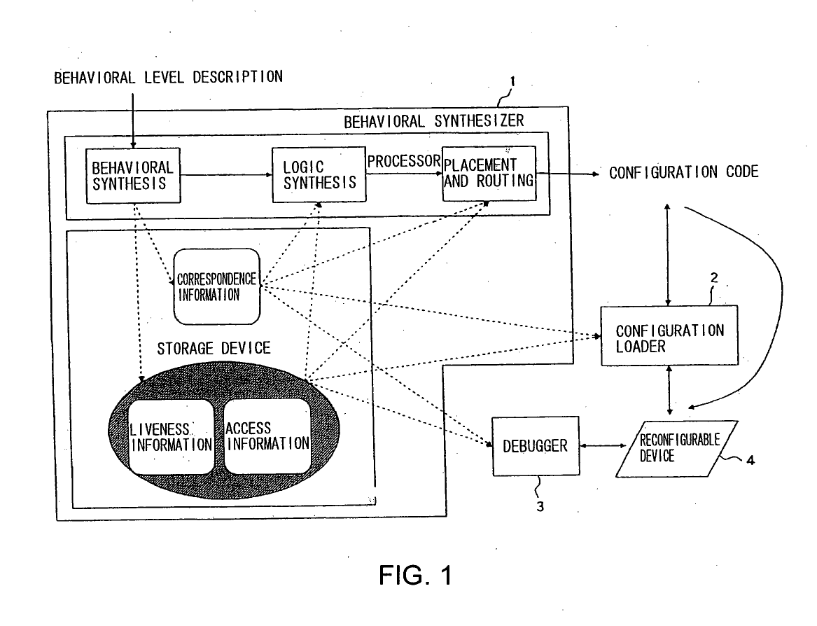

As shown in FIG. 1, a computer aided design system of the present invention includes: behavioral synthesizer 1 for performing behavioral synthesis, logic synthesis and placement and routing based on a behavioral level description to generate a configuration code; configuration loader (writing device) 2 for writing the configuration code generated by behavioral synthesizer 1 into reconfigurable device 4; and debugger 3 for debugging the configuration code generated by behavioral synthesizer 1.

Behavioral synthesizer 1 includes a processor which generates a configuration code by the steps of outputting a RTL circuit description by performing behavioral synthesis based on an input behavioral level description; preparing a net list by performing logic synthesis based on the RTL circuit description after behavioral synthesis; and performing a placement and routing (layout) process based on the net list; and a storage device for storing various pieces of information necessary for processing. Here, the storage device is not necessarily needed to be included in the behavioral synthesizer but may be a device that is independent from the behavioral synthesizer.

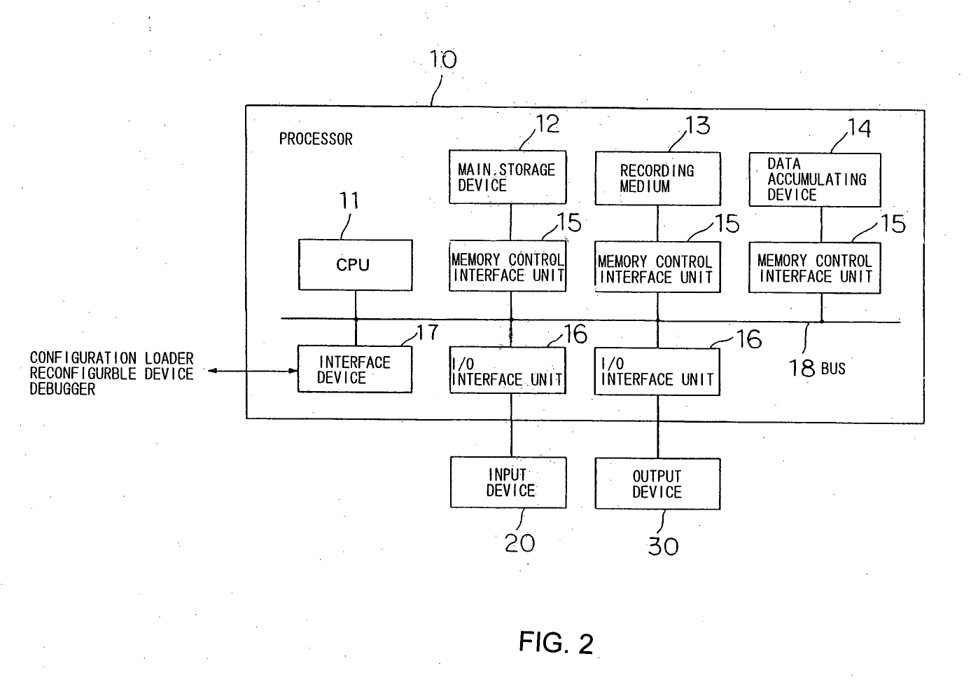

The processor and storage device may be realized by the LSI, logic circuitry, memory and the like for performing the processes of the aforementioned behavioral synthesis, logic component placement and routing or may be realized by an information processor (computer) as shown in FIG. 2.

The information processor shown in FIG. 2 includes: processor 10 for performing predetermined tasks in accordance with programs; input device 20 through which commands, information and the like are input to processor 10; and output device 30 to monitor the processing result from processor 10.

Processor 10 includes: CPU 11, main storage device 12 for temporarily storing the necessary information for processing by CPU 11; recording medium 13 on which the program for letting CPU 11 perform the processing as behavioral synthesizer 1 is recorded; data accumulating device 14 for storing the aftermentioned correspondence information, access information, liveness information etc.; memory control interface unit 15 for controlling data transfer between main storage device 12, recording medium 13 and data accumulating device 14; and I/O interface unit 16 as an interface unit for input device 20 and output device 30. Processor 10 further includes interface device 17 as an interface for exchanging information with configuration loader 2, debugger 3 and reconfigurable device 4. CPU 11, memory control interface unit 15, I/O interface unit 16 and interface device 17 are connected with each other by bus 18. Processor 10 may also have a communication controller as an interface for connection to a network. Data accumulating device 14 does not need to be included in processor 10, but may be a device that is independent from the processor.

Processor 10 executes the aforementioned behavioral synthesis, logic synthesis, placement and routing and other processes in accordance with the programs recorded on recording medium 13. Recording medium 13 may be a magnetic disc, semiconductor memory, optical disc or any other recording medium.

Stored in data accumulating device 14 are correspondence information, access information, and liveness information, obtained by behavioral synthesis. The correspondence information is information which shows the correspondence between the behavioral level description and the RTL circuit description generated by behavioral synthesis, specifically, it includes information on “correspondence between signals”, “correspondence on arithmetic operations”, “correspondence on source code” and other information.

An access information is information which shows the access status of reconfigurable device 4 to each storage element, including information showing “write” and “read” states and information showing a “hold” state in which data is held.

Liveness information is information which shows the periods during which the variables written in the behavioral level description are valid. Here, the variables are assumed to include also array variables and structure variables.

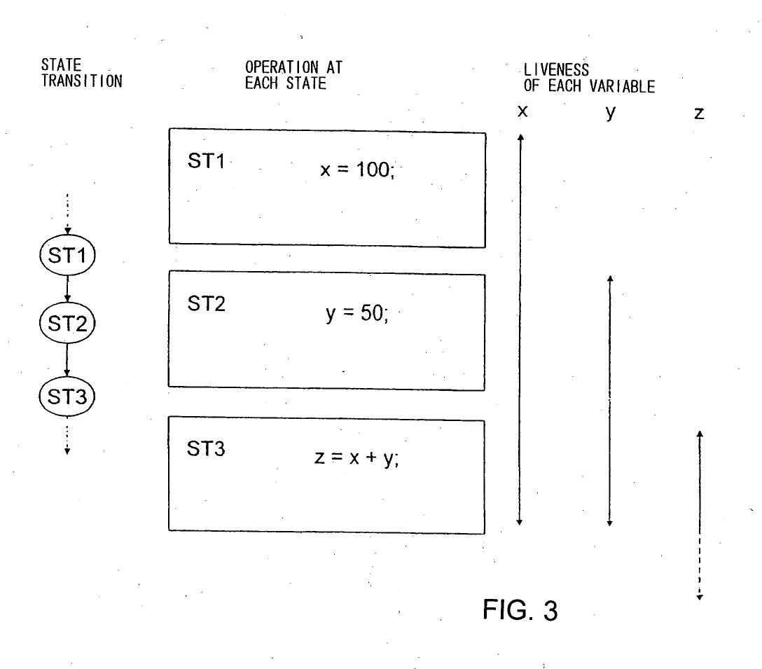

For example, as shown in FIG. 3, a case in which the process transits in the order of states ST1, ST2 and ST3, based on the behavioral level description, will be considered. In this case, variable x is defined at state ST1 and used for the operation at state ST3. That is, the liveness is from state ST1 to state ST3. Variable y is defined at state ST2 and is used for the operation at ST3, so the liveness is from state ST2 to state ST3. Though the end of the liveness of variable z is unknown since variable z is unclear after state ST3, the liveness starts from state ST3 since z is defined at state ST3.

In the present invention, use of this liveness information makes it possible to eliminate wasted operation and realize a computer aided design system capable of achieving various optimized designs.

Similarly to behavioral synthesizer 1, configuration loader 2 and debugger 3 may be realized with an LSI, logical circuitry and the like, or may be realized with an information processor (computer) as shown in FIG. 2.

When configuration loader 2 and debugger 3 are realized with an information processor, the processor performs the aftermentioned processing as configuration loader 2 or debugger 3 and stores the liveness information in the storage device (data accumulation device).

Next, the process of the computer aided design system of the present invention will be described specifically with reference to the following first to sixth embodiments.

### The First Embodiment

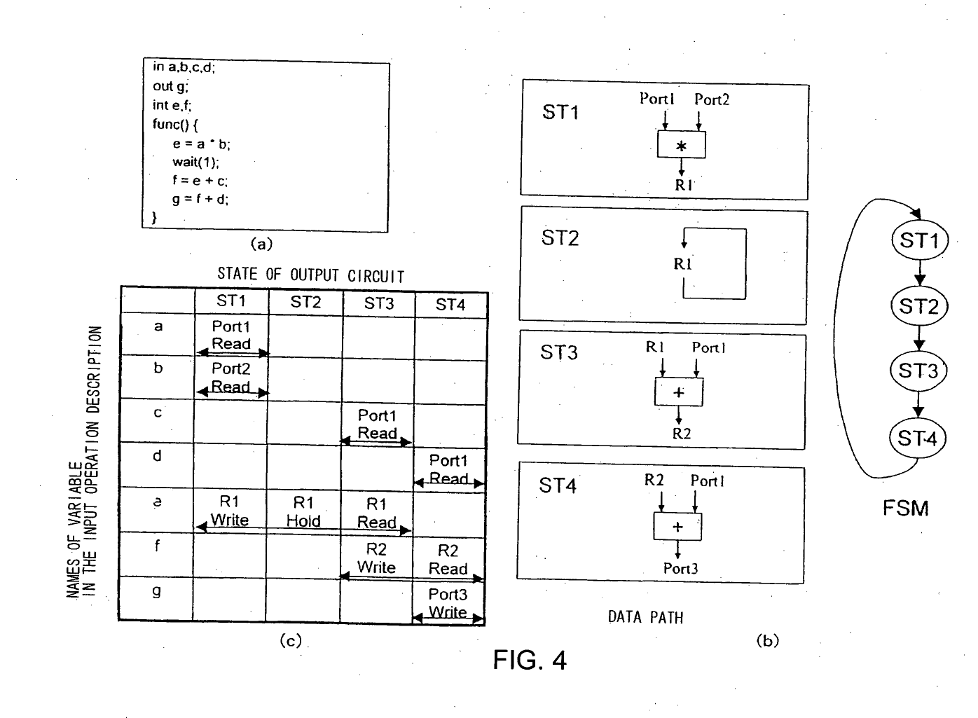

To begin with, a behavioral level description used in the first embodiment and an example of its behavioral synthesis result are shown in FIG. 4. FIG. 4(a) shows one example of a behavioral level description input to a behavioral synthesizer and FIG. 4(b) shows one example of an output circuit after behavioral synthesis. FIG. 4(c) is a table chart showing liveness of each variables. Symbols a, b, c and d shown in FIG. 4(a) are inputs and g is an output. Symbols e and f are variables.

The output circuit after behavioral synthesis is represented by a data path portion and an FSM (Finite State Machine) portion as shown in FIG. 4(b). This example shows that the behavioral level description shown in FIG. 4(a) is divided into four states ST1 to ST4, which transit one to the next in the order from states ST1 to ST4. In FIG. 4(b), R1 and R2 represent registers, Port 1 to Port 3 represent input and output terminals, “*” shows a multiplier and “+” shows an adder.

As shown in FIG. 4(c), in the output circuit created and based on the behavioral level description in FIG. 4(a), variable e is allocated to register R1 by behavioral synthesis and variable f is allocated to register R2 by behavioral synthesis. It is understood from the contents in FIG. 4(c) that the liveness of variable e is from states ST1 to ST3 and the liveness of variable f is from states ST3 to ST4. In FIG. 4(c), “Read” represents a read operation from a storage element and “Write” represents a write operation into a storage element and “Hold” represents a holding of a value in a storage element. Since Port 1 to Port 3 are non-storage elements, the liveness at these ports are only at the time of Read or Write.

The present embodiment is an example of optimizing the data path at the placement and routing stage based on the liveness information shown in FIG. 4(c).

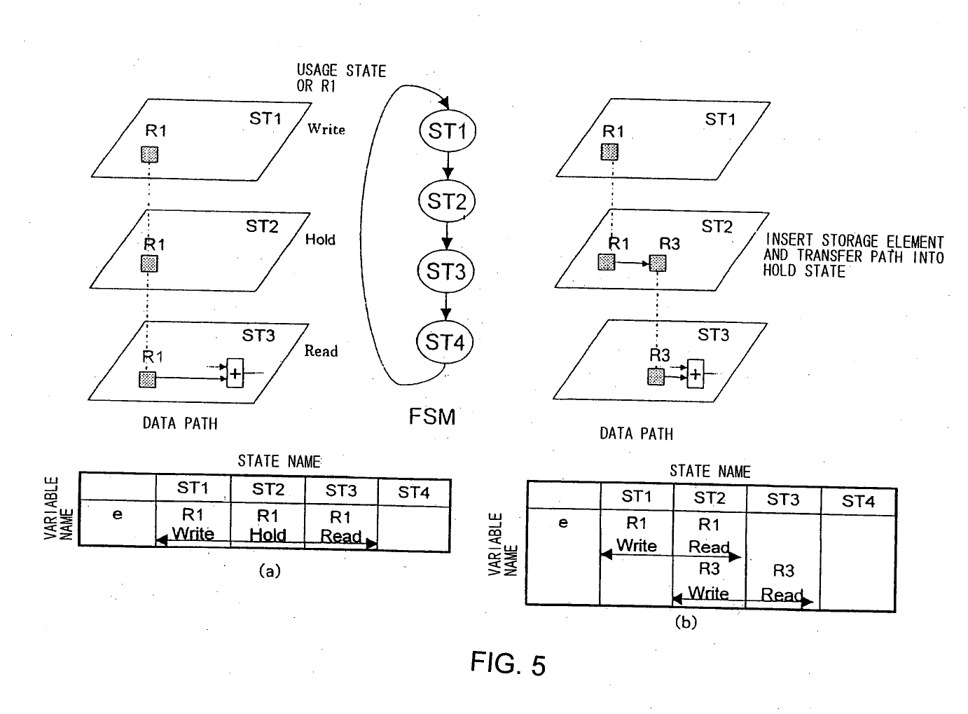

The result of processing in the first embodiment of the computer aided design system of the present invention is shown in FIG. 5. FIG. 5(a) shows one example of a data path and liveness information before the start of an optimizing processing, and FIG. 5(b) shows one example of a data path and liveness information after the completion of an optimizing processing.

The individual planes of the data paths shown in FIGS. 5(a) and 5(b) correspond to states ST1, ST2 and ST3. These planes can be interpreted as the switchable circuit planes (contexts) that are included in a reconfigurable device (e.g., DRP detailed in patent document 3, patent document 4, non-patent document 1 and the like) that is executable by switching multiple circuits.

As shown in FIG. 5(a), before optimization the liveness of variable e is from states ST1 to ST3; the value of variable e is written into register R1 at state ST1, the value of variable e is held during state ST2 and the value of variable e is read out from register R1 at state ST3.

Here, it is assumed that there is a register R3 that is not being used and the position into which variable e, that is read out from register R1 at state ST3, is located closer to register R3 than to register R1.

In this case, as shown in FIG. 5(b), an optimization is performed by transferring the value of variable e stored in register R1 at state ST2 to register R3 so as to read out variable e from register R3 at state ST3. This change of circuit will not change the result of the logic process. However, since the data path length can be shortened by the adaptation of reading out variable e from register R3 at state ST3, the amount of delay in the reading operation at state ST3 is reduced.

According to the present embodiment, use of liveness information in the behavioral synthesizer makes it possible to improve design flexibility in the placement and routing stage. As a result, when, for example an objective function aiming at reducing the propagation delay of signals is set up and the allocation of storage elements to the variables is modified in such a manner as to reduce or preferably to minimize the objective function, it is possible to reduce the amount of delay due to interconnections. In this case, it is preferred that a constraint that the number of registers inserted and the number of paths (transfer paths) generated by insertion of the registers will not exceed predetermined values, be added to the objective function.

In particular, when this embodiment is applied to a computer aided design system for designing a reconfigurable device such as the aforementioned DRP, interconnections are distributed to different circuit planes by the circuit plane switching device of the DRP. Accordingly, interconnection will never become difficult if registers and transfer paths are inserted. That is, it is possible to insert registers and transfer paths while maintaining ease of routing.

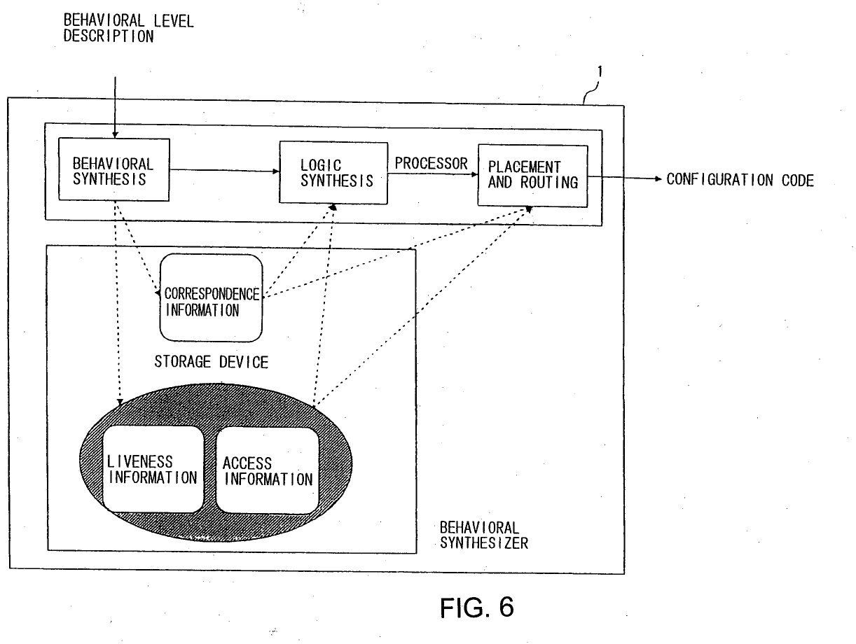

Here, in the present embodiment, the liveness information obtained by behavioral synthesis is used for the placement and routing stage of behavioral synthesizer 1 only, configuration loader 2 and debugger 3 shown in FIG. 1 are not needed, hence can be omitted. That is, the first embodiment forms a preferable example when it is used in a system configuration shown in FIG. 6.

### The Second Embodiment

Next, the second embodiment of a computer aided design system of the present invention will be described.

The second embodiment is an example of optimizing the design by sharing storage elements at the logic synthesizing stage or placement and routing stage, based on liveness information.

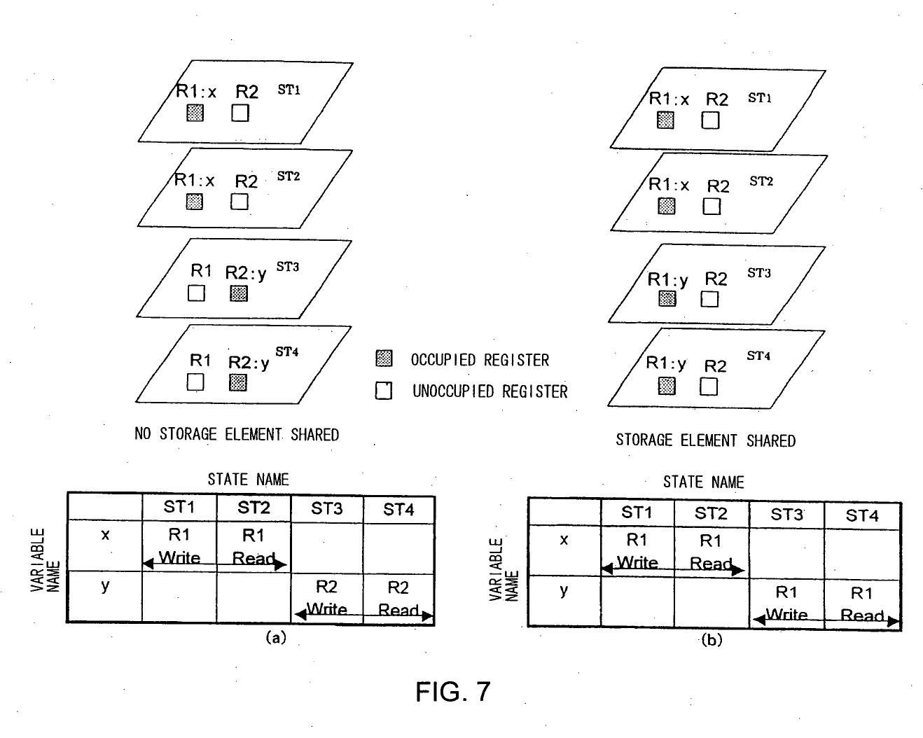

The result of the processing in the second embodiment of the computer aided design system of the present invention is shown in FIG. 7. FIG. 7(a) shows one example of a data path and liveness information before the state of optimizing processing, and FIG. 7(b) shows-one example of a data path and liveness information after the completion of an optimizing processing.

The individual planes of the data paths shown in FIGS. 7(a) and 7(b) correspond to states ST1, ST2, ST3 and ST4. These planes can be interpreted as switchable circuit planes (contexts) that are included in a reconfigurable device (e.g., DRP detailed in patent document 3, patent document 4, non-patent document 1 and the like) that is executable by switching multiple circuits.

In the example shown in FIG. 7(a), registers R1 and R2 are provided, and register R1 is used to hold variable x at state ST1 and state ST2 and register R2 is used to hold variable y at state ST3 and state ST4. In this case, since register R1 is not used at state ST3 and state ST4, it is also possible to use register R1 to hold variable y.

This circuit design for sharing storage elements may, in general, be applied to the behavioral synthesizing stage too. However, in the present embodiment, the design for sharing storage elements to be allocated to the variables in the logic synthesizing state or in the placement and routing stage is optimized by use of liveness information.

As in the present embodiment, when sharing of storage elements at the logic synthesizing stage is designed based on liveness information, it is possible to share the storage elements taking into account the total circuit performance. For example, when sharing of storage elements at the behavioral synthesizing stage is designed, it is necessary to design the way of sharing of storage elements based on information relating to the inaccurate, inherent characteristics of storage elements such as setup delays, hold delays and the like, or based on information that is more abstract, such as the bit width of the storage elements to which variables are allocated and such as the connecting information on data paths. As a result, there is a possibility that a multiple number of variables, which are not suitable to be shared in view of the total circuit performance, will be shared by a single storage element.

In contrast, as in the present embodiment, when storage elements are shared at the logic synthesizing stage based on liveness information, it is possible to design sharing of storage elements based on information relating to the accurate, inherent characteristics of storage elements. Also, since the bit width and connecting information on data paths have been determined, the problem discribed above will never occur.

Further, designing of a sharing of storage elements at the placement and routing stage based on liveness information as in the present embodiment makes it possible to share the storage elements taking into account the total circuit performance. For example, when sharing of storage elements at the behavioral synthesizing stage is designed, there is a possibility that variables of many fan-outs (many outputs) will be shared by a single register because the behavioral synthesizing stage has no indicators to consider the layout of storage elements. In this case, since it is difficult to route the storage element that shares multiple variables, an inability to register layout may be detected at the placement and routing stage. As a result, wasted operation such as redoing behavioral synthesis and the like may occur.

In contrast, when a process of sharing storage elements at the placement and routing stage as in the present embodiment is executed, the problem of this kind will not occur since allocation of storage elements can be done considering the layout.

Further, when a storage element is shared by multiple variables by taking into account the layout at the placement and routing stage as in the present embodiment and also when the process of allocating storage elements to variables, by taking into account wire delays as described in the first embodiment, is executed, it is possible to perform manipulations such as, for example, allocating storage elements to individual variables by giving priority to wire delays when a request is made for a circuit to operate at high-speed, or sharing storage elements when priority is given to the size of the layout area of a circuit. Accordingly, it is possible to achieve placement and routing taking into account total circuit performance such as the operation frequency and circuit area etc.

According to the present embodiment, use of liveness information in the behavioral synthesizer makes it possible to improve design flexibility in the behavioral synthesizing stage or in the placement and routing stage. As a result, when, for example an objective function aiming at reducing the number of storage elements to be used is set up and a configuration that permits storage elements allocated to the variables to be switched is designed in such a manner as to reduce or preferably to minimize the objective function, it is possible to enhance the operation frequency and to reduce the circuit area. In this case, it is preferred that, in the logic synthesizing stage, a constraint that the signal propagation delay will not exceed a predetermined value be added to the objective function. It is also preferred that in the placement and routing stage constraints that the signal propagation delay will not exceed a predetermined value and that ease of routing will not be lost be imposed.

In particular, when this embodiment is applied to a computer aided design system for designing a reconfigurable device such as the aforementioned DRP, it is possible to achieve register sharing, not by use of selector elements but by using a context (circuit plane) switching device provided for DRP. Accordingly, the number of selector elements will not increase. Further, interconnections are distributed to different contexts (circuit planes) included in the DRP by the context (circuit plane) switching device. Accordingly, no elongation of routing because of complex routing due to register sharing will occur, hence no increase in the amount of delay will occur. That is, the demerit due to register sharing can be alleviated.

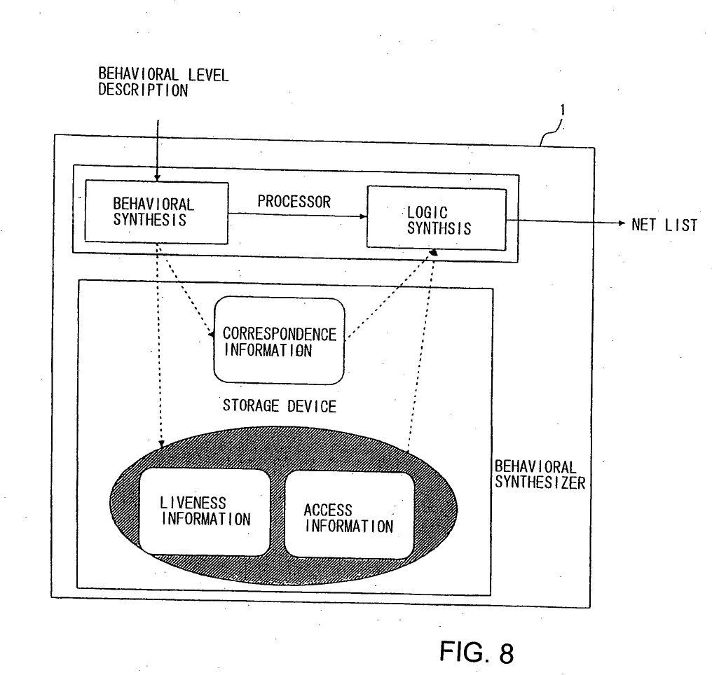

Here, the present embodiment is described by referring to the examples in which liveness information obtained by behavioral synthesis is used for the logic synthesizing stage and the placement and routing stage of behavioral synthesizer 1, configuration loader 2 and debugger 3 shown in FIG. 1 are not needed, hence can be omitted. That is, if liveness information is used at the logic synthesizing stage of behavioral synthesizer 1, the second embodiment forms a preferable example when it is used in a system configuration shown in FIG. 8. If liveness information is used at the placement and routing stage of behavioral synthesizer 1, the second embodiment forms a preferred example when it is used in a system configuration shown in FIG. 6 as in the first embodiment.

### The Third Embodiment

Next, the third embodiment of a computer aided design system of the present invention will be described.

The third embodiment is an example of optimizing the operation of debugger 3 based on liveness information.

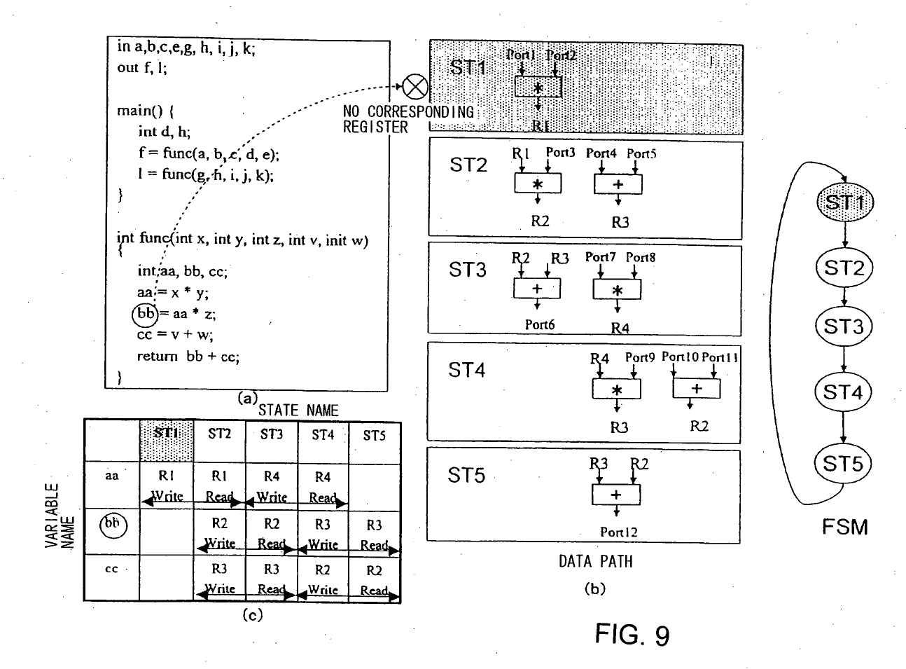

The result of processing in the third embodiment of a computer aided design system of the present invention is shown in FIG. 9. FIG. 9(a) shows one example of a behavioral level description input to the behavioral synthesizer, FIG. 9(b) shows one example of an output circuit after behavioral synthesis. FIG. 9(c) is a table chart showing liveness of each variables. Symbols a, b, c, e, g, h, i, j and k shown in FIG. 9(a) are input and f and l are output. Symbols aa, bb and cc represent variables.

As shown in FIG. 9(b), it is understood that in this example, the behavioral level description shown in FIG. 9(a) is divided by behavioral synthesis into five states ST1 to ST5, which transit one to the next in order from states ST1 to ST5. In FIG. 9(b), R1 to R4 represent registers, Port 1 to Port 12 represent input and output terminals, “*” shows a multiplier and “+” shows an adder.

As shown in FIG. 9(c), for variable aa used in the behavioral level description shown in FIG. 9(a), register R1 is allocated during states ST1 and ST2 and register R4 is allocated during states ST3 and ST4. For variable bb, register R2 is allocated during states ST2 and ST3 and register R3 is allocated during states ST4 and ST5. For variable cc, register R3 is allocated during states ST2 and ST3 and register R2 is allocated during states ST4 and ST5. It is understood from the contents in FIG. 9(c) that the liveness of variable aa is from states ST1 to ST4, the liveness of variable bb is from states ST2 to ST5 and the liveness of variable cc is from states ST2 to ST5.

When the output circuit shown in FIG. 9(b) is debugged, in the conventional debugger the contents of the storage elements to which individual variables are allocated are displayed based on the correspondence information shown in FIG. 1. Here, if the operator instructs the debugger to display the value of variable bb at state ST1, the debugger displays the values of registers R2 and R3 in accordance with the correspondence information. However, since no operation for determining variable bb is performed at state ST1 as shown in FIG. 9(c), the displayed values of registers R2 and R3 have no relation with the processing at state ST1.

In the present embodiment, debugger 3, by making use of liveness information, is able to determine that variable bb is not valid (not live) at state ST1, and generates a piece of information that shows variable bb does not have a valid value and performs display based on that information, instead of displaying meaningless values. Accordingly, display of unnecessary information at the time of debugging can be restrained., so that it is possible to improve debugging efficiency.

In particular, when the present embodiment is applied to a computer aided design system for designing a reconfigurable device such as the above-described DRP, the process at the time of debugging in the present embodiment can be easily realized because DRP have been previously prepared according to with a standardized control interface and a standardized interface for access to storage elements and hence high controllability and high observability are assured.

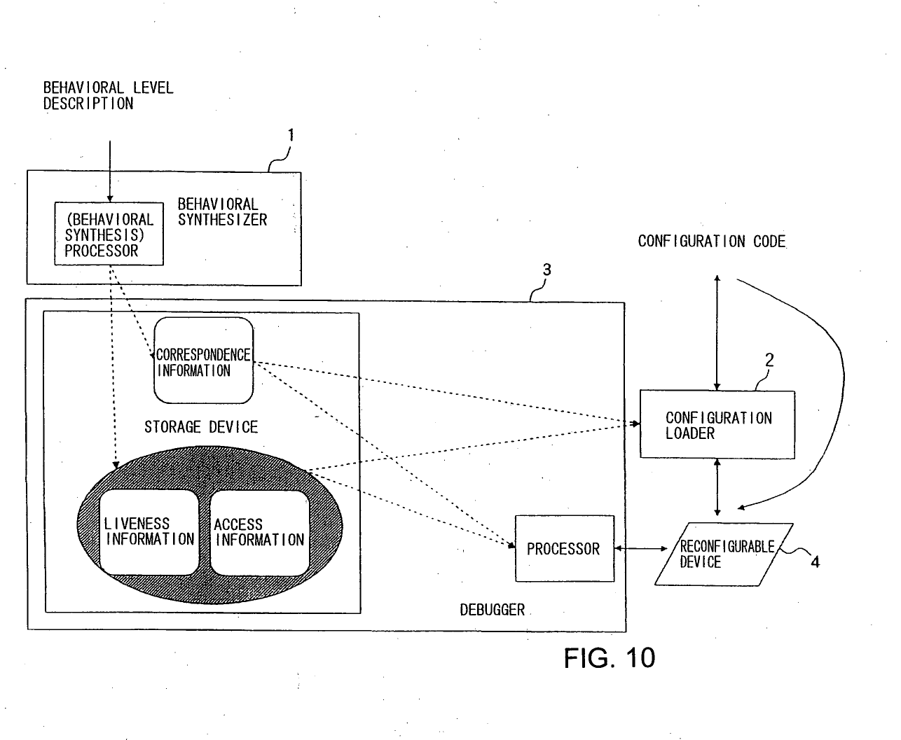

Here, in the present embodiment, liveness information obtained by behavioral synthesis is used at debugger 3 only. This means that the logic synthesis and the placement and routing which both are executed by behavioral synthesizer 1 shown in FIG. 1 are not needed, hence can be omitted. That is, the third embodiment forms a preferable example when it is used in a system configuration shown in FIG. 10. Further, since liveness information can be usually obtained from configuration codes and the like, once these have been compiled for debugger 3 it is no longer necessary to actuate behavioral synthesizer 1 in order to use liveness information for debugger 3. In this case, behavioral synthesizer 1 shown in FIG. 10 also becomes unneeded.

### The Fourth Embodiment

Next, the fourth embodiment of a computer aided design system of the present invention will be described.

The fourth embodiment is another example of optimizing operation with debugger 3 based on liveness information.

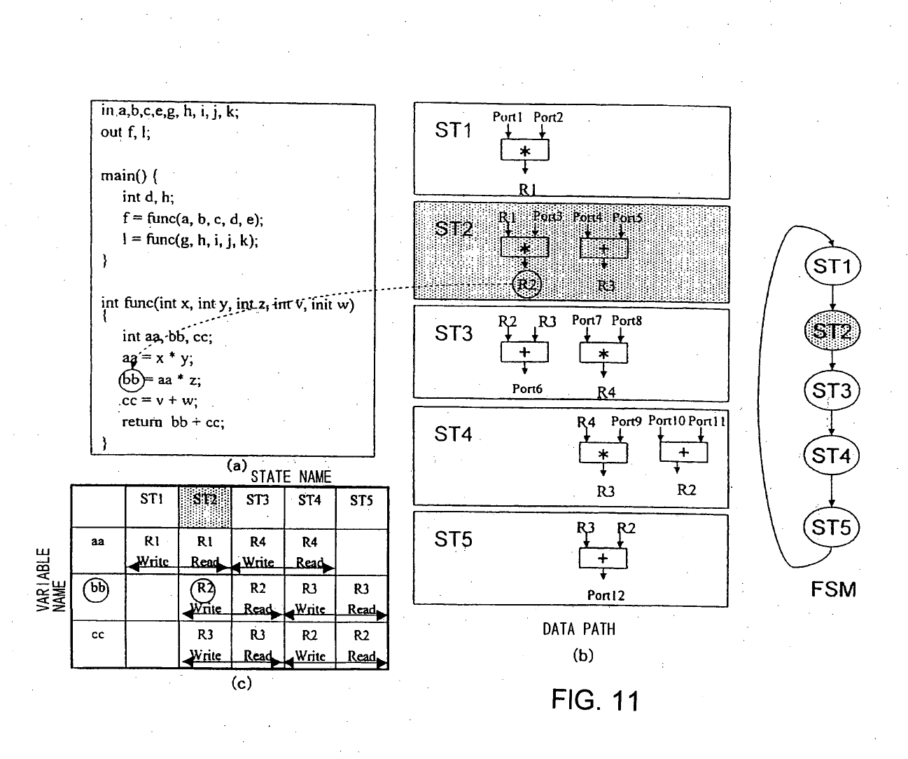

The result of processing in the fourth embodiment of a computer aided design system of the present invention is shown in FIG. 11. FIG. 11(a) shows one example of a behavioral level description input to the behavioral synthesizer, FIG. 11(b) shows one example of an output circuit after behavioral synthesis. FIG. 11(c) is a table chart showing liveness of each variables. Symbols a, b, c, e, g, h, i, j and k shown in FIG. 11(a) are input and f and l are output. Symbols aa, bb and cc represents variables.

As shown in FIG. 11(b), it is understood that in this example, the behavioral level description shown in FIG. 11(a) is divided by behavioral synthesis into five states ST1 to ST5, which transit one to the next in the order from states ST1 to ST5. In FIG. 11(b), R1 to Reconfigurable device 4 represent registers, Port 1 to Port 12 represent input and output terminals, “*” shows a multiplier and “+” shows an adder.

As shown in FIG. 11(c), for variable aa used in the behavioral level description shown in FIG. 11(a), register R1 is allocated during states ST1 and ST2 and register R4 is allocated during states ST3 and ST4. For variable bb, register R2 is allocated during states ST2 and ST3 and register R3 is allocated during states ST4 and ST5. For variable cc, register R3 is allocated during states ST2 and ST3 and register R2 is allocated during states ST4 and ST5. It is understood from the contents in FIG. 11(c) that the liveness of variable aa is from states ST1 to ST4, the liveness of variable bb is from states ST2 to ST5 and the liveness of variable cc is from states ST2 to ST5.

When the output circuit shown in FIG. 11(b) is debugged, in the conventional debugger the contents of the registers to which individual variables are allocated are displayed based on the correspondence information shown in FIG. 1. Here, if the operator instructs the debugger to display the value of the variable which is allocated to register R2 in state ST2, the debugger displays the values of variables bb and cc based on the correspondence information. However, since no operation for determining variable cc is performed at state ST2 as shown in FIG. 11(c), variable cc has no relation with the processing at state ST2.

In the present embodiment, debugger 3, by making use of the liveness information, is able to determine that variable cc is not allocated to register R2 at state ST2. Accordingly, the debugger generates information for displaying the value of variable bb only and performs display based on the generated information, instead of displaying meaningless values. As a results, display of unnecessary information can be restrained during debugging, so that debugging efficiency can be improved.

In particular, when the present embodiment is applied to a computer aided design system for designing a reconfigurable device such as the above-described DRP, the processing at the time of debugging in the present embodiment can be easily realized because DRP have been previously prepared according to a standardized control interface and a standardized interface for access to storage elements and hence high controllability and high observability are assured.

Similarly to the third embodiment, also in the present embodiment liveness information obtained by behavioral synthesis is used at debugger 3 only, so that the logic synthesis and the placement and routing which both are executed by behavioral synthesizer 1 shown in FIG. 1 are not needed, hence can be omitted. That is, the fourth embodiment forms a preferable example when it is used in the system configuration shown in FIG. 10. Further, since liveness information can be usually obtained from configuration codes and the like, once these have been compiled for debugger 3, it is no longer necessary to actuate behavioral synthesizer 1 in order to use liveness information for debugger 3. In this case, behavioral synthesizer 1 shown in FIG. 10 also becomes unnecessary.

### The Fifth Embodiment

Next, the fifth embodiment of a computer aided design system of the present invention will be described.

The fifth embodiment is an example of optimizing the processing of configuration loader (writing device) 2 shown in FIG. 1, based on liveness information.

As described above, reconfigurable device 4 has an internal memory for storing configuration codes therein, loads a configuration code into the internal memory under the control of configuration loader 2, configures a circuit therein in accordance with the loaded configuration code and executes a process of inputting data with this circuit. Since there is a limit to the storage capacity of this internal memory, the internal memory is used time-divisionally so as to realize a plurality of circuits.

Usually, if a configuration code of a new circuit is written into the internal memory beyond the storage capacity of the internal memory, in order to secure an empty area, it is necessary to save the circuit that has been stored in the internal memory to the external memory and also to save all the contents of the storage elements used for that circuit to the external memory.

An architecture of this kind in which a process is executed time-divisionally with a plurality of circuits by writing configuration codes successively into the internal memory beyond its storage capacity is called virtual HW (hardware).

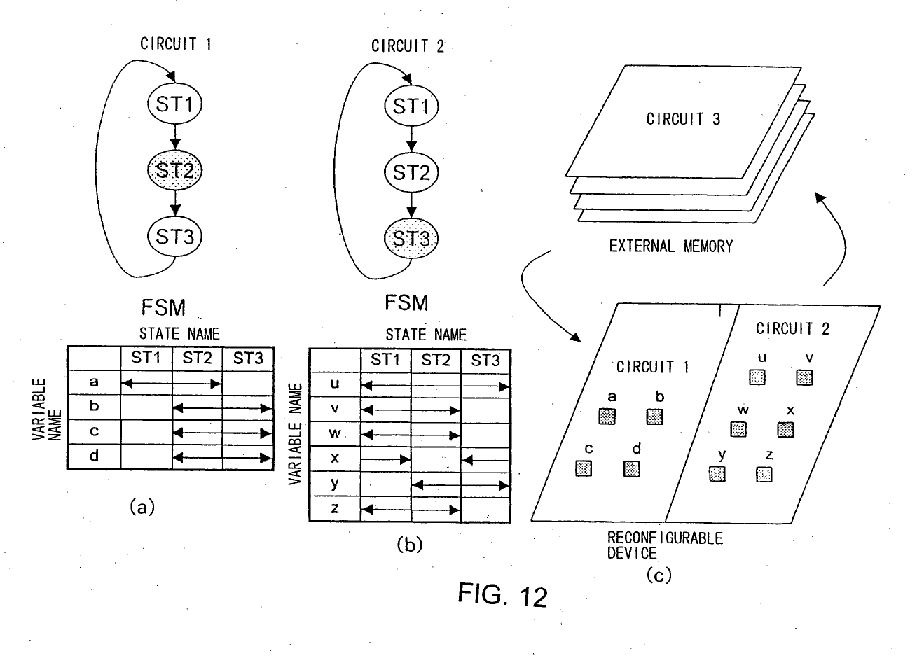

The result of the processing of the fifth embodiment of the computer aided design system of the present invention is shown in FIG. 12. FIGS. 12(a) and 12(b) show examples of the state transition and liveness information of circuits constructed in a reconfigurable device, and FIG. 12(c) shows a manner in which circuits are permuted.

Here, consider an example in which two circuits (circuit 1 and circuit 2) are formed in reconfigurable device 4 as shown in FIGS. 12(a) and 12(b), and either of these two circuits is permuted with another circuit (circuit 3) stored in the external memory.

Herein, it is assumed that a FSM and liveness information shown in FIG. 12(a) are obtained based on circuit 1 and a FSM and liveness information shown in FIG. 12(b) are obtained based on circuit 2. It is also assumed that circuit 1 stops its processing at state ST2 and circuit 2 stops its processing at state ST3.

In this case, with reference to the liveness information, in circuit 1 the variables (valid variables) that exist at state ST2 and after are b, c and d, meaning that the number of storage elements whose stored content is saved to the external memory is three.

On the other hand, in circuit 2, x is the only variable (valid variable) that exists at state ST3 and after, meaning that the number of storage elements whose stored content is saved to the external memory is one.

Accordingly, when the configuration code of circuit 3 needs to be loaded into the internal memory of reconfigurable device 4, to save of circuit 2 to the external memory can be done with a lower amount of data transfer between reconfigurable device 4 and the external memory.

In the present embodiment, use of liveness information by configuration loader 2 makes it possible to determine that the contents of the storage elements that hold invalid variables on and after the present state do not need to be saved to the external memory. Accordingly, to save a circuit to the external memory, it is possible to select the one which having a lower number of storage elements whose contents should be saved to the external memory. It is therefore possible to perform rewriting of circuits with a reduced amount of data transfer between reconfigurable device 4 and the external memory.

According to the present embodiment, liveness information is adapted to be used in the processing of configuration loader 2. Accordingly, when, for example an objective function aimed at reducing the amount of data to be saved from the storage elements to the external memory at the time of circuit reconfiguration is set up and circuits to be constructed in the reconfigurable device are changed over so as to reduce or preferably to minimize the objective function, it is possible to reduce the amount of the contents of the storage elements to be saved to the external memory. It is hence possible to reduce the amount of data transfer between reconfigurable device 4 and the external memory. In this case, it is preferred that a constraint, that a correct operation should be guaranteed when the saved data is restored, be added to the objective function.

In particular, when this embodiment is applied to a computer aided design system for designing a reconfigurable device such as the aforementioned DRP, this configuration is optimal for realizing virtual HW because the overhead at the time of switching the circuits to be constructed in the DRP can be reduced by the context (circuit plane) switching device provided for the DRP and by a partial reconfiguring device which enables configuration codes to be written into an unused context during operation.

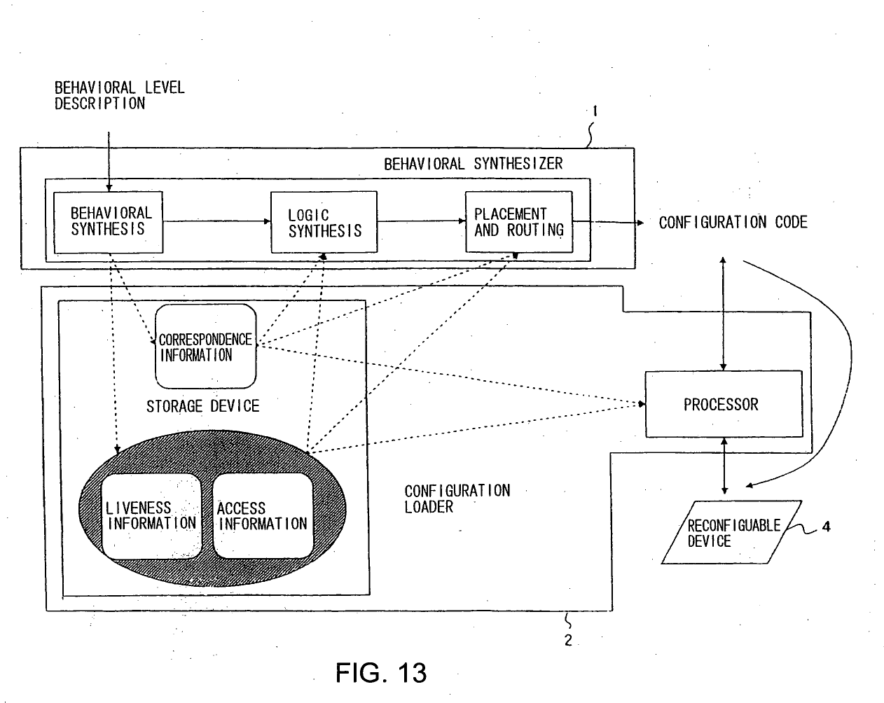

Here, in the present embodiment, the liveness information obtained by behavioral synthesis is used at configuration loader 2 only, debugger 3 shown in FIG. 1 is not needed, hence can be omitted. That is, the fifth embodiment forms a preferable example when it is used in a system configuration shown in FIG. 13.

### The Sixth Embodiment

Next, the sixth embodiment of a computer aided design system of the present invention will be described.

The sixth embodiment is an example of optimizing the processing of configuration loader (writing device) 2 shown in FIG. 1, based on liveness information.

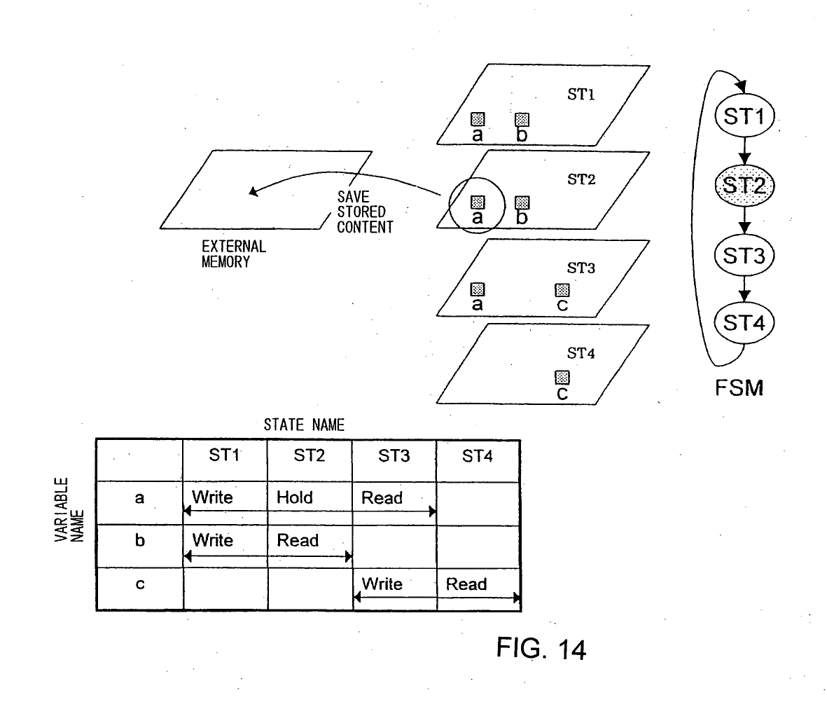

The result of the processing of the sixth embodiment of the computer aided design system of the present invention is shown in FIG. 14. FIG. 14 shows the state transition and liveness information of a circuit constructed in a reconfigurable device.

Considered in the sixth embodiment is an example in which the scale of a circuit to be configured in reconfigurable device 4 based on a behavioral level description is too large to construct all the states (states ST1 to ST4 in FIG. 14) of the circuit at the same time so that the processing of states ST3 and ST4 is executed after permutation of circuitry after completion of the processing of states ST1 and ST2.

In this case, reconfigurable device 4 needs to stop its operation at state ST2, save the circuitry stored in the internal memory to the external memory and save all the contents of storage elements being used by that circuitry to the external memory, then load the configuration codes for realizing states ST3 and ST4 from the external memory.

Here, as shown in FIG. 14, with reference to the liveness infomation, the liveness of variable a is from states ST1 to ST3, the liveness of variable b is from states ST1 to ST2 and the liveness of variable c is from states ST3 to ST4, meaning that at state ST2 only the value of variable a should be saved to the external memory. Therefore, in this case, only the value of variable a is saved to the external memory by configuration loader 2.

Accordingly, in the computer aided design system of the present embodiment, it is possible to reduce the amount of the contents of the storage elements to be saved to the external memory, hence reduce the amount of data transfer between reconfigurable device 4 and the external memory.

According to the present embodiment, similarly to the fifth embodiment, liveness information is adapted to be used in the processing of configuration loader 2. Accordingly, when, for example an objective function aimed at reducing the amount of data to be saved from the storage elements to the external memory at the time of circuit reconfiguration is set up and circuits to be constructed in the reconfigurable device are changed over so as to reduce or preferably to minimize the objective function, it is possible to reduce the amount of the contents of the storage elements to be saved to the external memory. It is hence possible to reduce the amount of data transfer between reconfigurable device 4 and the external memory. In this case, it is preferred that a constraint that a correct operation should be guaranteed when the saved data is restored is added to the objective function.

In particular, when this embodiment is applied to a computer aided design system for designing a reconfigurable device such as the aforementioned DRP, this configuration is optimal for realizing virtual HW because the overhead at the time of switching the circuits to be constructed in the DRP can be reduced by the context (circuit plane) switching device provided for the DRP and by a partial reconfiguring device which enables configuration codes to be written into an unused context during operation.

Here, in the present embodiment, liveness information that is obtained by behavioral synthesis is used at configuration loader 2 only, similarly to the fifth embodiment debugger 3 shown in FIG. 1 and is not needed and can be omitted. That is, the sixth embodiment forms a preferable example when it is used in a system configuration shown in FIG. 13.

While preferred embodiments of the present invention have been described using specific terms, such description is for illustrative purposes only, and it is to be understood that changes and variations may be made without departing from the spirit or scope of the following claims.

What is claimed is:

1. A behavioral synthesizer which executes behavioral synthesis, logic synthesis and placement and routing in accordance with a behavioral level description that describes the behavior of a semiconductor integrated circuit device and generates information representing the configuration, placement and routing for a circuit to be designed, said behavioral synthesizer comprising:
a processor which, based on the liveness information that is obtained from the behavioral synthesis and that shows the periods during which variables described in the behavioral level description have valid values, allocates the variables to storage elements provided for the semiconductor integrated circuit device at a design stage subsequent to the behavioral synthesis so that a previously set objective function will become small; and
a storage device for storing the liveness information.

2. The behavioral synthesizer according to claim 1, wherein said processor sets up an objective function at the placement and routing stage based on signal propagation delay and switches the storage elements to be allocated to the variables so that the objective function will become small.

3. The behavioral synthesizer according to claim 1, wherein said processor sets up an objective function at the logic synthesizing stage based on the number of storage elements to be used and the signal propagation delay and uses the storage elements to be allocated to the variables in common so that the objective function will become small.

4. The behavioral synthesizer according to claim 1, wherein said processor sets up an objective function at the placement and routing stage based on the number of storage elements to be used and the signal propagation delay and uses the storage elements to be allocated to the variables in common so that the objective function will become small.

5. A debugger for debugging the information that is generated by executing behavioral synthesis, logic synthesis and placement and routing in accordance with a behavioral level description that describes the operation of a semiconductor integrated circuit device and that shows the configuration, placement and routing for a circuit to be designed, said debugger comprising:
a processor which, when the value of an arbitrary variable at an arbitrary state is directed to be displayed, and if the value of the variable at the designated state is invalid, generates a piece of information that shows that the variable is invalid, based on the liveness information that is obtained from the behavioral synthesis and shows the periods during which the variables described in the behavioral level description have valid values; and
a storage device for storing the liveness information.

6. A debugger for debugging the information that is generated by executing behavioral synthesis, logic synthesis and placement and routing in accordance with a behavioral level description that describes the operation of a semiconductor integrated circuit device and that shows the configuration, placement and routing for a circuit to be designed, said debugger comprising:
a processor which, when the variables stored in arbitrary storage elements at arbitrary states are directed to be displayed, generates a piece of information for displaying only the variables that have been stored in the storage elements having valid values at the designated states, based on the liveness information that is obtained from the behavioral synthesis and that shows the periods during which the variables described in the behavioral level description have valid values; and
a storage device for storing the liveness information.

7. A writing device for writing the information that is generated by executing behavioral synthesis, logic synthesis and placement and routing in accordance with a behavioral level description that describes the operation of a semiconductor integrated circuit device and that shows the configuration, placement and routing for a circuit to be designed, into the semiconductor integrated circuit device, said writing device comprising:
a processor which, based on the liveness information that is obtained from the behavioral synthesis and that shows the periods during which variables described in the behavioral level description have valid values, saves the contents held in storage elements provided for the semiconductor integrated circuit device to an external memory so that a previously set objective function will become small; and
a storage device for storing the liveness information.

8. The writing device according to claim 7, wherein, when information representing the configuration, placement and routing for a new circuit is written into storage elements provided for the semiconductor integrated circuit device, to an extent that exceeds the storage capacity of the storage elements, the processor sets up an objective function aimed at reducing the amount of data to be saved to the external memory and saves the contents held in the storage elements that store the information representing the configuration, placement and routing for a circuit and this makes the objective function small.

9. The writing device according to claim 7, wherein, when information representing the configuration, placement and routing for a new circuit is written into an internal memory provided for the semiconductor integrated circuit device, to an extent that exceeds the storage capacity of the internal memory, the processor sets up an objective function aimed at reducing the amount of data to be saved to the external memory and saves the contents held in the storage elements to the external memory and this makes the objective function small.

10. A computer aided design system for supporting circuit design of the semiconductor integrated circuit device, including a behavioral synthesizer, debugger or writing device according to claim 1.

11. A computer aided design system for supporting circuit design of the semiconductor integrated circuit device, including a behavioral synthesizer, debugger or writing device according to claim 5.

12. A computer aided design system for supporting circuit design of the semiconductor integrated circuit device, including a behavioral synthesizer, debugger or writing device according to claim 6.

13. A computer aided design system for supporting circuit design of the semiconductor integrated circuit device, including a behavioral synthesizer, debugger or writing device according to claim 7.

14. A circuit design supporting method for executing behavioral synthesis, logic synthesis and placement and routing in accordance with a behavioral level description that describes the operation of a semiconductor integrated circuit device and generates information representing the configuration, placement and routing for a circuit to be designed, wherein a computer stores the liveness information, that is obtained from the behavioral synthesis and that shows the periods during which variables described in the behavioral level description have valid values, into a storage device, and allocates, based on the liveness information, the variables to storage elements provided for the semiconductor integrated circuit device at a design stage subsequent to the behavioral synthesis so that a previously set objective function will become small.

15. The circuit design supporting method according to claim 14, wherein the computer sets up an objective function at the placement and routing stage based on signal propagation delay and switches the storage elements to be allocated to the variables so that the objective function will become small.

16. The circuit design supporting method according to claim 14, wherein the computer sets up an objective function at the logic synthesizing stage based on the number of storage elements to be used and signal propagation delay and uses the storage elements to be allocated to the variables in common so that the objective function will become small.

17. The circuit design supporting method according to claim 14, wherein the computer sets up an objective function at the placement and routing stage based on the number of storage elements to be used and signal propagation delay and uses the storage elements to be allocated to the variables in common so that the objective function will become small.

18. A circuit design supporting method for debugging the information that is generated by executing behavioral synthesis, logic synthesis and placement and routing in accordance with a behavioral level description that describes the operation of a semiconductor integrated circuit device and that shows the configuration, placement and routing for a circuit to be designed, wherein a computer stores the liveness information, that is obtained from the behavioral synthesis and that shows the periods during which variables described in the behavioral level description have valid values, into a storage device, and, when the value of an arbitrary variable at an arbitrary state is directed to be displayed, and if the value of the variable at the designated state is invalid, the computer generates a piece of information that shows that the variable is invalid, based on the liveness information that is obtained from the behavioral synthesis and that shows the periods during which the variables described in the behavioral level description have valid values.

19. A circuit design supporting method for debugging the information that is generated by executing behavioral synthesis, logic synthesis and placement and routing in accordance with a behavioral level description that describes the operation of a semiconductor integrated circuit device and that shows the configuration, placement and routing for a circuit to be designed, wherein a computer stores the liveness information, that is obtained from the behavioral synthesis and that shows the periods during which variables described in the behavioral level description have valid values, into a storage device, and, when the variables stored in arbitrary storage elements at arbitrary states are directed to be displayed, the computer generates a piece of information for displaying only the variables that have been stored in the storage elements having valid values at the designated states, based on the liveness information that is obtained from the behavioral synthesis and that shows the periods during which the variables described in the behavioral level description have valid values.

20. A circuit design supporting method for writing the information that is generated by executing behavioral synthesis, logic synthesis and placement and routing in accordance with a behavioral level description that describes the operation of a semiconductor integrated circuit device and that shows the configuration, placement and routing for a circuit to be designed, into the semiconductor integrated circuit device,
wherein a computer stores the liveness information that is obtained from the behavioral synthesis and that shows the periods during which variables described in the behavioral level description have valid values, into a storage device, and saves the contents held in storage elements provided for the semiconductor integrated circuit device to an external memory so that a previously set objective function will become small, based on the liveness information.

21. The circuit design supporting method according to claim 20, wherein, when information representing the configuration, placement and routing for a new circuit is written into storage elements provided for the semiconductor integrated circuit device, to an extent that exceeds the storage capacity of the storage elements, the computer sets up an objective function aimed at reducing the amount of data to be saved to the external memory and saves the contents held in the storage elements that store the information representing the configuration, placement and routing for a circuit and this makes the objective function small.

22. The circuit design supporting method according to claim 20, wherein, when information representing the configuration, placement and routing for a new circuit is written into an internal memory provided for the semiconductor integrated circuit device, to an extent that exceeds the storage capacity of the internal memory, the computer sets up an objective function aimed at reducing the amount of data to be saved to the external memory and saves the contents held in the storage elements to the external memory and this makes the objective function small.
